(19) United States
(12) Patent Application Publication
(10) Pub. No.: US 2005/0116077 A1
(43) Pub. Date: Jun. 2, 2005

(54) Mill liner profile

(75) Inventors: John A. Herbst, Colorado Springs, CO (US); Xiangjun Qiu, Colorado Springs, CO (US)

Correspondence Address: FOLEY & LARDNER, 777 EAST WISCONSIN AVENUE, SUITE 3800, MILWAUKEE, WI, 53202-5308, US

(73) Assignee: Metso Minerals Industries, Inc.

(21) Appl. No.: 10/871,541

(22) Filed: Jun. 18, 2004

Related U.S. Application Data
(60) Provisional application No. 60/479,671, filed on Jun. 18, 2003.
(60) Provisional application No. 60/508,050, filed on Oct. 2, 2003.

(51) Int. Cl. B02C 19/00

(52) U.S. Cl. 241/299

(57) ABSTRACT

The mill includes an inner circumferential surface having a profile including a lifter portion having a variable angle edge.

The present application claims under 35 USC Section 119 priority from co-pending U.S. provisional patent application Ser. Nos. 60/479,671 and 60/508,050, and entitled INTERIOR MILL PROFILE AND LINER, filed on Jun. 18, 2003 and Oct. 2, 2004, respectively, by John A. Herbst and Xiangjun Qiu, the full disclosures of which are hereby incorporated by reference.

### BRIEF DESCRIPTION OF THE DRAWINGS

FIG. 1 is a perspective view of a grinding mill having an interior mill profile according to one exemplary embodiment of the present invention.

FIG. 1A is a fragmentary sectional view of the mill of FIG. 1 taken along the line 1A-1A.

FIG. 2 is a diagram illustrating one embodiment of an interior mill profile of the mill of FIG. 1 according to an exemplary embodiment.

FIG. 3 is a diagram illustrating the first portion of another embodiment of interior profile of the mill of FIG. 1 according to an exemplary embodiment.

FIG. 4 is a diagram illustrating a second portion of the other embodiment of interior profile of the mill of FIG. 1 according to an exemplary embodiment.

### DETAILED DESCRIPTION OF EXAMPLE EMBODIMENTS

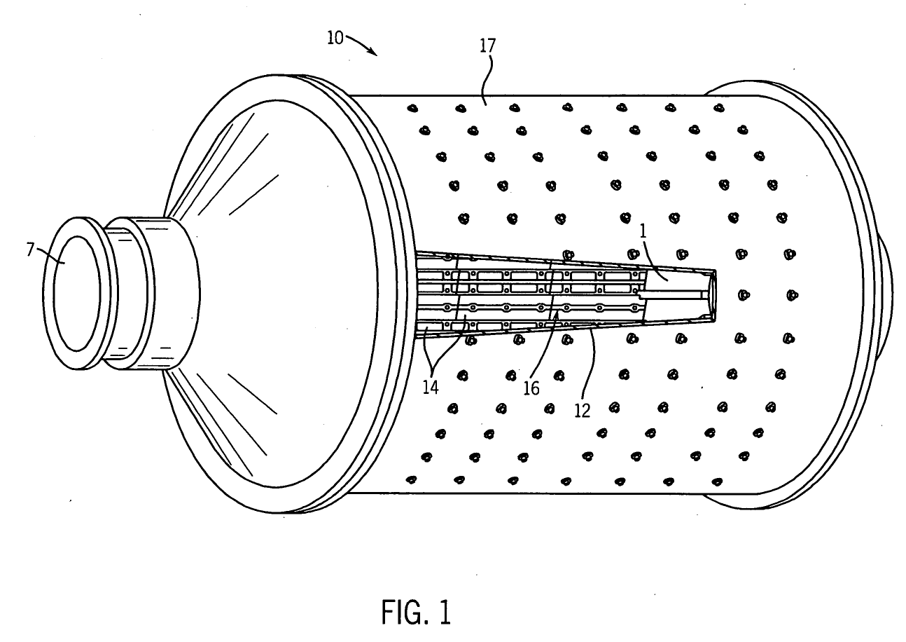

FIG. 1 illustrates mill 10 which has an interior 12 with an inner circumferential profile 16 (schematically shown). In one embodiment, profile 16 is provided by a plurality of individual segments or liners 14 secured to the inner surfaces of cylindrical wall 17. In alternative embodiments, profile 16 may be provided by other liners supported along the inner circumferential surface of mill 10 or may be integrally formed as part of a single unitary body with wall 17.

FIG. 1A is a sectional view of mill 10 illustrating profile 16 in greater detail. As shown by FIG. 1A, profile 16 is formed by liners 14 which are secured to an interior of wall 17 in a side-by-side relationship. In the particular example shown, liners 14 are secured to wall 17 by fasteners 19, such as bolts formed which pass through wall 17 into corresponding bores 21 intermittently within liners 14. In the particular example shown, each liner 14 has a high lifter portion 18 and a portion of a speed bump portion 20. When liners 14 are positioned adjacent to one another along wall 17, the adjacent portions of speed bumps 20 form a complete speed bump. In other embodiments, liners 14 may be mounted to wall 17 by other fasteners, the junction between liners 14 may be altered and liners 14 may be secured to wall 17 in other fashions.

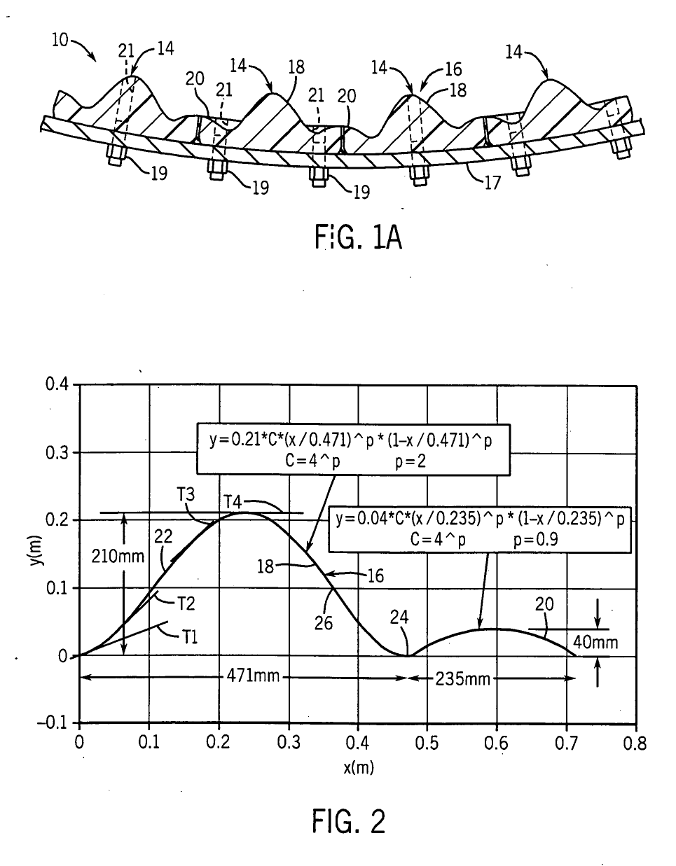

FIG. 2 illustrates one particular embodiment of liner profile 16 in detail. FIG. 2 is a sectional view along the surface of profile 16. Profile 16 is generally the contour or boundary surface facing the interior 12 of mill 10. Profile 16 is defined by the equation: y=A (x/B)^{p}(1-x/B)^{p}, where y is the height of profile 16 from a lowermost point of profile 16, where x is the distance from the start of profile 16 and where the parameters A, B and p are chosen to optimize performance based on criteria such as mill diameter, filling percent of the mill, character of material being processed and the rotational velocity of the mill. Profile 16 is continuously repeated along the entire inner circumferential surface of the mill 10. It has been discovered that a profile 16 generally following the above equation has superior performance as compared to other standard profiles. In particular, profile 16 achieves longer liner wear life and/or higher grinding mill throughput.

As further shown by FIG. 2, profile 16 generally forms a high lifter portion 18 and a speed bump portion 20. In other embodiments, speed bump 20 may be omitted. When profile 16 is repeated along the entire inner circumferential surface 12 of mill 10, portions 18 and 20 are interleaved with one another along surface 12. High lifter portion 18 comprises a raised area of profile 16 having a variable angle. In particular, portion 18 has an edge 22 bounded by tangents T1, T2, T3 and T4. Tangents T1-T4 extend at varying angles with respect to one another. T1 has a low angle. T2 has a larger angle. T3 has a large angle. T4 has a lower angle again. This varying angle of edge 22 has been found to achieve longer wear life and/or higher grinding throughput as compared to conventional profiles.

As shown by FIG. 2, portions 18 and 20 are symmetrical in that their leading and trailing edges are identical. As a result, profile 16 is well suited for use in bidirectional mills. The ratio of the heights of portions 16 and 18 may vary depending upon operating conditions such as those listed above.

Although profile 16 is illustrated as being continuous with no breaks or junctions between segments, profile 16 may be provided by multiple segments or sections aligned side-to-side within mill 10. In alternative embodiments, parts of portions 18 or 20 may be provided by different sections or segments. For example, in lieu of segment junction 24, profile 16 may be formed by segments having a junction at location 26. In still another embodiment, profile 16 may be integrally formed as a single unitary segment or may be integrally formed as part of a segment including multiple repeating profiles 16. In lieu of being formed by liners 14, profile 16 may be integrally formed with wall 17 of mill 10.

FIG. 2 illustrates one particular application of profile 16 to a particular mill 10. In the embodiment shown, mill 10 comprises a 34 foot diameter semi-autogenous (SAG) grinding mill having 44 steel liners 14 along its inner circumferential surface. Alternatively, liners 14 may be formed from other materials or combination of materials including rubber, polymers and other metals. The SAG mill has a fill percentage of about 30 percent by volume (10-20 percent fill by balls). The SAG mill processes gold ore and rotates at a speed of between about 9.5 and 11 revolutions per minute. It has been found that the detailed profile 16 shown in FIG. 2 optimally performs (wear and throughput) in such conditions.

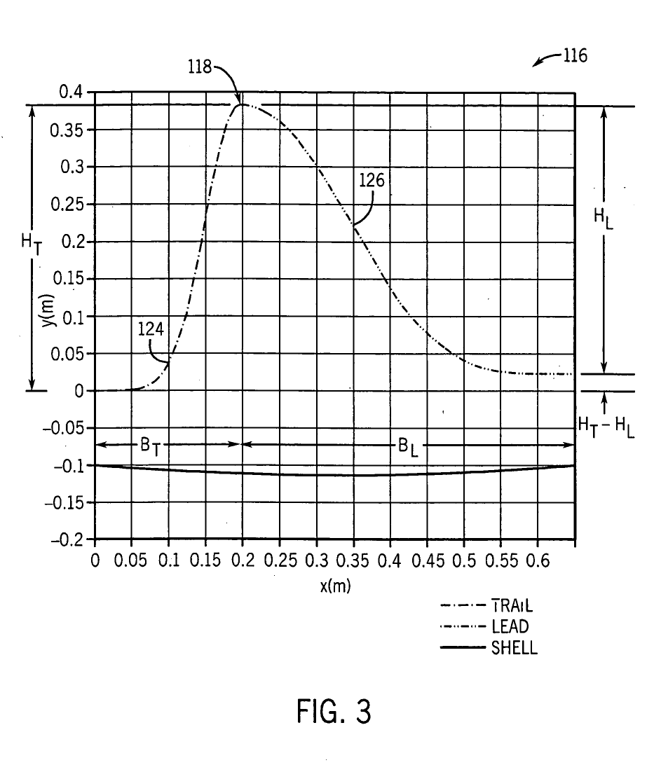

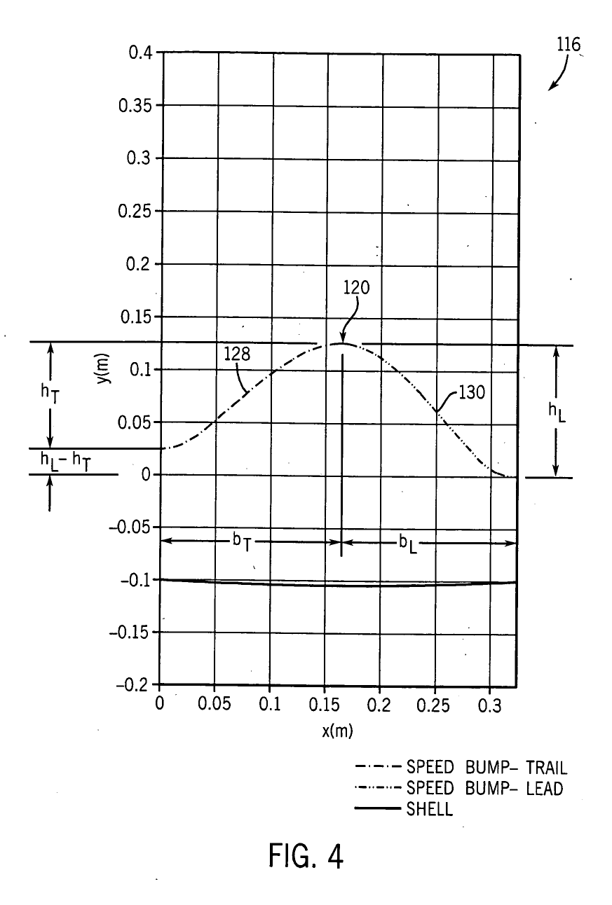

FIGS. 3 and 4 illustrate liner profile 116, an alternative embodiment of liner profile 16. FIG. 3 is a sectional view of lifter portion 118 of liner 116. FIG. 4 is a sectional view of a speed bump portion 120 of profile 116. Liner profile 116 extends along an interior 12 of mill 10 shown in FIG. 1. Profile 116 of high lifter 118 is generally defined by the following equations:
Trailing Side:

$$y = {{H}_{T} ( \frac{x}{{B}_{T}} )}^{{q}_{T}} {( 2 - \frac{x}{{B}_{T}} )}^{{q}_{T}} 0 \leq x \leq {B}_{T}$$

Leading Side:

$$y = {{H}_{L} ( \frac{x - {B}_{T} + {B}_{L}}{{B}_{L}} )}^{{q}_{L}} {( 2 - \frac{x - {B}_{T} + {B}_{L}}{{B}_{L}} )}^{{q}_{L}} + {H}_{T} - {H}_{L} {B}_{T \leq x \leq } {B}_{T} + {B}_{L}$$

where q_{T}>0, q_{L}>0, B_{T}>0, B_{L}>0, H_{T}>0 and H_{L}>0,
where x is the distance from the start of lifter portion 118, where y is the height of profile 116 of portion 118, where B_{T} is the length of the trailing edge, where B_{L} is the length of the leading edge 126, where H_{T} is the height of the trailing edge, where H_{L} is the height of the trailing edge 124.

As shown by FIG. 4, speed bump portion 120 has a trailing edge or side 128 and a leading edge or side 130. Profile 116 of speed bump portion 120 is defined by the following equations (also found in Exhibit C):
Trailing Side:

$$y = {{h}_{T} ( \frac{x}{{b}_{T}} )}^{{P}_{T}} {( 2 - \frac{x}{{b}_{T}} )}^{{P}_{T}} + {h}_{L} - {h}_{T} 0 \leq x \leq {b}_{T}$$

Leading Side:

$$y = {{h}_{L} ( \frac{x - {b}_{T} + {b}_{L}}{{b}_{L}} )}^{{P}_{L}} {( 2 - \frac{x - {b}_{T} + {b}_{L}}{{b}_{L}} )}^{{P}_{L}} {b}_{T} \leq x \leq {b}_{T} + {b}_{L}$$

where P_{T}>0, P_{L}>0, b_{T}>0, b_{L}>0 and h_{L}>0,
where x is the distance from the start of speed bump portion 120, where y is the height of profile 116 of speed bump portion 128, where b_{T} is the length of the trailing edge portion 128, where b_{L} is the length of the leading edge 128 of portion 128, where h_{T} is the height of the trailing edge of portion 128 and where h_{L} is the height of trailing edge 130 of portion 128.

Profile 116 is continuously repeated along the entire inner circumferential surface of mill 10. In particular, lifter portion 118 and speed bump portion 120 are alternated about the entire inner circumferential surface of mill 10. It has been discovered that a profile 116 generally following the equations has superior performance in unidirectional milling as compared to other standard profiles. In particular, profile 116 provides for longer life and/or higher grinding mill throughput.

In one embodiment, profile 116 is continuous with no breaks or junctions between segments. In another embodiment, profile 116 may be provided by multiple segments or sections aligned side-to-side within mill 10. For example, in one embodiment, a first section may provide portion 118 while a second section provides portion 120. In alternative embodiments, parts of portions 118 or 120 may be provided by different sections or segments. In still another embodiment, profile 116 may be integrally formed as a single unitary segment or may be integrally formed as part of a segment including multiple sets of portions 118 and 120. In lieu of being formed by liners 14, profile 116 may be integrally formed with wall 18 of mill 10.

In one embodiment, mill 10 comprises a 34 foot diameter semi-autogenous (SAG) grinding mill having 44 steel liners 14 along its inner circumferential surface. Alternatively, liners 14 may be formed from other materials or combinations of materials including rubber, polymers and other metals. The SAG mill has a fill percentage of about 30% by volume (10-20% fill by balls). The SAG mill processes gold ore and rotates at a speed of between 9.5 and 11 revolutions per minute.

Profiles 16 and 116 are at least, in part, defined by various parameters chosen to optimize performance based on various criteria such as mill diameter, filling percent of the mill, character of the material being processed and the rotation of velocity of the mill. For example, in one embodiment, the parameters of profiles 16 and 116 are chosen to optimize performance based upon multi-physics modeling. The techniques used in multi-physics modeling include one or more of discrete element modeling (DEM), computational fluid dynamics (CFD), and discrete grain breakage (DGB).

DEM simulations focus on discrete “particles” by solving Newton's Second Law of motion applied to a particle of mass mᵢ moving with velocity vᵢ when it is acted upon by a collection of forces fᵢⱼ including gravitational forces and particle-particle, particle-fluid and particle boundary interactive forces, i.e.,

$$\frac{D ( {m}_{i} {v}_{i} )}{Dt} = {\sum }^{} {f}_{ij} \qquad ( 1 )$$

If particle motion is confined to two directions the simulation is referred to as 2D-DEM; if full three directional movement is allowed the simulation is referred to as 3D-DEM. For mineral processing design applications the “particles” are generally ore particles, grinding media pieces or bubbles. Constitutive equations can be provided for interactive forces, energy dissipation, wear and breakage.

CFD simulations focus on continuous flow behavior of fluids and slurries modeled as pseudo-fluids by solving a modified form of the full Navier Stokes Equation, i.e.,

$$ρ \frac{Dv}{Dt} = - ∇ P + η {∇}^{2} v + ρ g + ( \frac{1}{1 - ɛ} ) {f}_{i} \qquad ( 2 )$$

at any point in the continuous phase x, y, z. The last term is a fluid-particle interaction term which accounts for losses resulting from mutual interactions. DGB simulations focus on discrete particles in the same way that DEM does except in this case each physical particle is made up of discrete grains into which strain energy can be stored/released and cracks can propagate along their boundaries governed by the energy conservation equation which governs crack extension force, G, i.e.,

$$G = - \frac{1}{2 t} \frac{δ u}{δ a} \qquad ( 3 )$$

where u is the stored strain energy around the crack, a is the crack length and t is the crack width.

These techniques are used to model the charge motion within the mill. One direct output from this modeling is a complete history of all impact events in the mill and their magnitude. This history of the magnitude, direction and duration of the impact events dissipated inside the mill (energy spectra) are used to determine the wear rate of a liner profile, and in combination with the breakage characteristics of the ore being treated, the throughput capacity of the mill. As the liners wear, the liner profile changes, and therefore also the energy spectra, during the life cycle of the liners. A relationship is developed between the mill throughput capacity and the condition of the liner profile over the life of the liner. This throughput capacity/liner life relationship, together with the liner wear data, are combined with economic data from the mill being optimized and are used to generate a Nett Present Value (NPV) model for the mill. Such an NPV model clearly defines the financial benefit of one liner profile over the other. This NPV data, or alternatively a more simplified criteria of maximum liner life or maximum mill throughput capacity, are used to generate the parameter values that are used in the liner profiles 16 and 116.

In the particular applications described above, it has been found that selection or identification of the parameters for the equations forming profiles 16 and 116 may be limited to the following ranges:
H_{L}, H_{T}, h_{L} and h_{T}: >5 mm
P, q_{L}, q_{T}, P_{L}, and P_{T}: 0.00001-20.0, 2.7-12.8, 13.8-50.8, and >52.8
B, B_{L}, B_{T}, b_{T}, and b_{L}: >5 mm

Profiles 16 and 116 have overall characteristics that have been found to optimize throughput of the mill and/or life of the liner. Although profiles 16 and 116 are generally defined by the above described equations, inconsequential or insubstantial changes may be made to such profiles which may result in portions of the profile not precisely meeting the described equations, but which may still achieve the through put and/or prolonged life. For example, a profile which does not exactly follow the above defined equations may still achieve the noted benefits if the alternative profile meets the following criteria.

Given two liner profiles, for the leading or trailing part of each of the two liner lifters, or for the leading or trailing part of each of the two liner speed bumps:
i) Calculate the equal-weighted root-mean-square (RMS) of the difference between the height (y co-ordinates) of the two liner profiles along the entire length (x co-ordinates) of the leading or trailing edge, and
ii) calculate the equal-weighted mean value of the height of the lifter or the speed bump, measured with respect to the base of the lifters or speed bump, and
iii) divide the calculated value of the difference in the lifter height (RMS) by the calculated mean value of height of the lifter or speed bump and define the quotient as the error.

If the error as defined above is less than 5%, then the liner profile would be considered similar to that described.

Although profiles 16 and 116 are illustrated and described and utilized in an SAG mill, inner profiles 16 and 116 may alternatively be utilized by other grinding applications. For example, profiles 16 and 116 may alternatively be utilized in cylindrical, rod and pebble mills, conical ball and pebble mills batch mills, vibrating ball mills, stirred media mills and other mills.

Although the present invention has been described with reference to example embodiments, workers skilled in the art will recognize that changes may be made in form and detail without departing from the spirit and scope of the invention. For example, although different embodiments may have been described as including one or more features providing one or more benefits, it is contemplated that the described features may be interchanged with one another or alternatively be combined with one another in the described example embodiment or in other alternative embodiments. Because the technology of the present invention is relatively complex, not all changes in the technology are foreseeable. The present invention described with reference to the example embodiment and set forth in the above definitions is manifestly intended to be as broad as possible. For example, unless specifically otherwise noted, the definitions reciting a single particular element also encompass a plurality of such particular elements.

1. A mill comprising:
an inner circumferential surface having a profile defined by the following equation: y=A(x/B)^{p}(1-x/B)^{p}.

2. The mill of claim 1 wherein A and B are greater than 5 millimeters and wherein p is chosen from one of the ranges including 0.000001-2.0, 2.7-12.8, 13.8-50.8, and greater than 52.8.

3. The mill of claim 1 wherein the parameters A, B and p are chosen based upon at least one of the following: mill rotation speed, mill diameter, fill percentage and material being processed by mill.

4. The mill of claim 1 wherein the mill comprises a metallic mineral grinding mill.

5. The mill of claim 4 wherein the mill is bidirectional.

6. The mill of claim 5 wherein the mill is a semi-autogenous grinding mill.

7. A mill comprising:
an inner circumferential surface having a profile including:
a lifter portion having a variable angle edge; and
a bump portion adjacent the lifter portion.

8. A liner system for a mill, the system comprising:
a plurality of adjacent liner segments having a continuous surface defined by the following equation: y=A(x/B)^{p}(1-x/B)^{p}.

9. The system of claim 8 wherein A and B are greater than 5 millimeters and wherein p is chosen from one of the ranges including 0.000001-2.0, 2.7-12.8, 13.8-50.8, and greater than 52.8.

10. A liner system for a mill, the system comprising:
a plurality of adjacent liner segments having a continuous surface including:
a lifter portion having a variable angle edge; and
a bump portion adjacent the lifter portion.

11. A liner segment comprising:
a lifter portion having a variable angle edge.

12. The segment of claim 11 wherein the lifter portion is symmetrical.

13. A mill comprising:
an inner circumferential surface having a first portion with a first trailing side profile defined by the following equation:
$$y = {{H}_{T} ( \frac{x}{{B}_{T}} )}^{{q}_{T}} {( 2 - \frac{x}{{B}_{T}} )}^{{q}_{T}} ,$$
wher 0≦x≦B_{T};
a first leading side profile defined by the following equation:
$$y = {{H}_{L} ( \frac{x - {B}_{T} + {B}_{L}}{{B}_{L}} )}^{{q}_{L}} {( 2 - \frac{x - {B}_{T} + {B}_{L}}{{B}_{L}} )}^{{q}_{L}} + {H}_{T} - {H}_{L} ,$$
where B_{T}≦x≦B_{T}+B_{L}, where q_{T}>0, q_{L}>0, B_{T}>0, B_{L}>0, H_{T}>0 and H_{L}>0,
where x is the distance from the start of lifter portion, where y is the height of profile of portion, where B_{T} is the length of the trailing edge, where B_{L} is the length of the leading edge, where H_{T} is the height of the trailing edge, where H_{L} is the height of the trailing edge; and
a second portion having a second trailing side profile defined by the following equation:
$$y = {{h}_{T} ( \frac{x}{{b}_{T}} )}^{{P}_{T}} {( 2 - \frac{x}{{b}_{T}} )}^{{P}_{T}} + {h}_{L} - {h}_{T} ,$$
where 0≦x≦b_{T}; and
a second leading side profile defined by the following equation:
$$y = {{h}_{L} ( \frac{x - {b}_{T} + {b}_{L}}{{b}_{L}} )}^{{P}_{L}} {( 2 - \frac{x - {b}_{T} + {b}_{L}}{{b}_{L}} )}^{{P}_{L}} ,$$
where b_{T}≦x≦b_{T}+b_{L},
where q_{T}>0, q_{L}>0, B_{T}>0, B_{L}>0, H_{T}>0 and H_{L}>0,
where P_{T}>0, P_{L}>0, b_{T}>0, b_{L}>0, h_{T}>0 and h_{L}>0,
where x is the distance from the start of speed bump portion, where y is the height of profile of speed bump portion, where b_{T} is the length of the trailing edge portion, where b_{L} is the length of the leading edge of portion, where h_{T} is the height of the trailing edge of portion and where h_{L} is the height of trailing edge of portion.

14. The mill of claim 13 wherein H_{L}, H_{T}, h_{L}, and h_{T} are greater than 5 millimeters, wherein Q_{L}, Q_{T}, P_{L}, and P_{T} are chosen from within at least one of the following ranges: 00001-2.0, 2.7-12.8, 13.8-50.8, and greater than 52.8, and wherein B_{L}, B_{T}, b_{T}, and b_{L} are greater than 5 millimeters.

15. The mill of claim 13, wherein the mill comprises a metallic integral grinding mill.

16. The mill of claim 15, wherein the mill is unidirectional.

17. The mill of claim 13, wherein the mill is a semi-autogenous grinding mill.

18. A liner system for a mill, the system comprising:
a plurality of adjacent liner segments having a continuous surface including a lifter portion, the lifter portion having a first trailing side profile defined by the following equation:
$$y = {{H}_{T} ( \frac{x}{{B}_{T}} )}^{{q}_{T}} {( 2 - \frac{x}{{B}_{T}} )}^{{q}_{T}} ,$$
where 0≦x≦B_{T};
a first leading side profile defined by the following equation:
$$y = {{H}_{L} ( \frac{x - {B}_{T} + {B}_{L}}{{B}_{L}} )}^{{q}_{L}} {( 2 - \frac{x - {B}_{T} + {B}_{L}}{{B}_{L}} )}^{{q}_{L}} + {H}_{T} - {H}_{L} ,$$
where B_{T≦x≦}B_{T}+B_{L},
where q_{T}>0, q_{L}>0, B_{T}>0, B_{L}>0, H_{T}>0 and H_{L}>0,
where x is the distance from the start of lifter portion, where y is the height of profile of portion, where B_{T} is the length of the trailing edge, where B_{L} is the length of the leading edge, where H_{T} is the height of the trailing edge, where H_{L} is the height of the trailing edge; and
bump portion adjacent the lifter portion, the bump portion having a second trailing side profile defined by the following equation:
$$y = {{h}_{T} ( \frac{x}{{b}_{T}} )}^{{P}_{T}} {( 2 - \frac{x}{{b}_{T}} )}^{{P}_{T}} + {h}_{L} - {h}_{T} ,$$
where 0≦x≦b_{T}; and
a second leading side profile defined by the following equation:
$$y = {{h}_{L} ( \frac{x - {b}_{T} + {b}_{L}}{{b}_{L}} )}^{{P}_{L}} {( 2 - \frac{x - {b}_{T} + {b}_{L}}{{b}_{L}} )}^{{P}_{L}} ,$$
where b_{T}≦x≦b_{T}+b_{L},
where q_{T}>0, q_{L}>0, B_{T}>0, B_{L}>0, H_{T}>0 and H_{L}>0,
where P_{T>}0, P_{L}>0, b_{T}>0, b_{L}>0, h_{T}>0 and h_{L}>0,
where x is the distance from the start of speed bump portion, where y is the height of profile of speed bump portion, where b_{T} is the length of the trailing edge portion, where b_{L} is the length of the leading edge of portion, where h_{T} is the height of the trailing edge of portion and where h_{L} is the height of trailing edge of portion.

19. The liner system of claim 18 wherein H_{L}, H_{T}, h_{L}, and h_{T} are greater than 5 millimeters, wherein Q_{L}, Q_{T}, P_{L}, and P_{T} are chosen from within at least one of the following ranges: 00001-2.0, 2.7-12.8, 13.8-50.8, and greater than 52.8, and wherein B_{L}, B_{T}, b_{T}, and b_{L} are greater than 5 millimeters.

20. A liner segment comprising:
an inner circumferential surface having a first portion with a first trailing side profile defined by the following equation:
$$y = {{H}_{T} ( \frac{x}{{B}_{T}} )}^{{q}_{T}} {( 2 - \frac{x}{{B}_{T}} )}^{{q}_{T}} 0 \leq x \leq {B}_{T} ;$$
a first leading side profile defined by the following equation:
$$y = {{H}_{L} ( \frac{x - {B}_{T} + {B}_{L}}{{B}_{L}} )}^{{q}_{L}} {( 2 - \frac{x - {B}_{T} + {B}_{L}}{{B}_{L}} )}^{{q}_{L}} + {H}_{T} - {H}_{L} ,$$
where B_{T≦x≦}B_{T}+B_{L},
where q_{T}>0, q_{L}>0, B_{T}>0, B_{L}>0, H_{T}>0 and H_{L}>0,
where x is the distance from the start of lifter portion, where y is the height of profile of portion, where B_{T} is the length of the trailing edge, where B_{L} is the length of the leading edge, where H_{T} is the height of the trailing edge, where H_{L} is the height of the trailing edge.
a second portion having a second trailing side profile defined by the following equation:
$$y = {{h}_{T} ( \frac{x}{{b}_{T}} )}^{{P}_{T}} {( 2 - \frac{x}{{b}_{T}} )}^{{P}_{T}} + {h}_{L} - {h}_{T} ,$$
where 0≦x≦b_{T}; and
a second leading side profile defined by the following equation:
$$y = {{h}_{L} ( \frac{x - {b}_{T} + {b}_{L}}{{b}_{L}} )}^{{P}_{L}} {( 2 - \frac{x - {b}_{T} + {b}_{L}}{{b}_{L}} )}^{{P}_{L}} ,$$
where b_{T}≦x≦b_{T}+b_{L},
where q_{T}>0, q_{L}>0, B_{T}>0, B_{L}>0, H_{T}>0 and H_{L}>0,
where P_{T}>0, P_{L}>0, b_{T}>0, b_{L}>0, h_{T}>0 and h_{L}>0,
a second trailing side profile defined by the following equation:
$$y = {{h}_{T} ( \frac{x}{{b}_{T}} )}^{{P}_{T}} {( 2 - \frac{x}{{b}_{T}} )}^{{P}_{T}} + {h}_{L} - {h}_{T} ,$$
where 0≦x≦b_{T}; and
a second leading side profile defined by the following equation:
$$y = {{h}_{L} ( \frac{x - {b}_{T} + {b}_{L}}{{b}_{L}} )}^{{P}_{L}} {( 2 - \frac{x - {b}_{T} + {b}_{L}}{{b}_{L}} )}^{{P}_{L}} ,$$
where b_{T}≦x≦b_{T}+b_{L},
where q_{T}>0, q_{L}>0, B_{T}>0, B_{L}>0, H_{T}>0 and H_{L}>0,
where P_{T}>0, P_{L}>0, b_{T}>0, b_{L}>0, h_{T}>0 and h_{L}>0,
where x is the distance from the start of speed bump portion, where y is the height of profile of speed bump portion, where b_{T} is the length of the trailing edge portion, where b_{L} is the length of the leading edge of portion, where h_{T} is the height of the trailing edge of portion and where h_{L} is the height of trailing edge of portion.

21. The liner segment of claim 20 wherein at least one of H_{L}, H_{T}, h_{L}, h_{T}, Q_{L}, Q_{T}, P_{L}, P_{T}, B_{L}, B_{T}, b_{T}, and b_{L} is determined using multi-physics modeling.
